(19) United States
(12) Patent Application Publication
(10) Pub. No.: US 2007/0140527 A1
(43) Pub. Date: Jun. 21, 2007

(54) On-board image-recognizing apparatus, on-board image-shooting apparatus, on-board image-shooting controller, warning apparatus, image recognizing method, image shooting method, and image-shooting controlling method

(75) Inventors: Tetuo Yamamoto, Hyogo (JP); Katsumi Sakata, Hyogo (JP); Yoshikazu Hashimoto, Hyogo (JP)

Correspondence Address: OLIFF & BERRIDGE, PLC, P.O. BOX 19928, ALEXANDRIA, VA, 22320, US

(73) Assignee: FUJITSU TEN LIMITED, KOBE-SHI (JP)

(21) Appl. No.: 11/598,620

(22) Filed: Nov. 14, 2006

(30) Foreign Application Priority Data
Dec. 19, 2005 (JP) 2005-364764

(51) Int. Cl. G06K 9/00

(52) U.S. Cl. 382/104

(57) ABSTRACT

An image shooting unit is installed on a vehicle and shoots an image of an area around the vehicle at a set frame rate. A recognizing unit performs image recognition on the image to check whether an object is present in the image. A frame rate setting unit increases the frame rate in the image shooting unit when an object is present in the image so that more images are acquired per unit time.

### BACKGROUND OF THE INVENTION

1. Field of the Invention

The present invention generally relates to a technology for acquiring an image of an area around a vehicle and detecting a pedestrian in the image based on image recognition.

2. Description of the Related Art

Recently, technologies for detecting an object such as a pedestrian based on image recognition have been proposed. For example, Japanese Patent Application Laid-Open No. S61-162702 discloses a technology that acquires a background image that contains only stationary objects, obtains a real image that could contain moving objects, and compares luminance or brightness of the real image with those of the background image to detect moving objects presenting the image.

When performing image recognition, the frame rate of an image is crucial. When displaying an image (particularly, a moving picture) on a display device, the frame rate is the number of times of refreshing a screen of the display device per unit time. When shooting an image, the frame rate is the number of times of shooting a frame of the image per unit time. If the frame rate is high, there is an advantage that the movements can be shot or displayed more smoothly; however there is a disadvantage that the data volume increases.

In image recognition, a low frame rate results in a long interval in object recognition. Specifically, when a time difference between two subsequent frames in an image becomes larger, the amount of movement of an object in the image also becomes larger, so that a distance between the vehicle and the object suddenly becomes closer by a frame. This may cause a delay in detecting the object or performing warning to the driver of the vehicle. On the other hand, a high frame rate results in a high processing load, whereby heat release and electric power consumption are increased.

### SUMMARY OF THE INVENTION

It is an object of the present invention to at least partially solve the problems in the conventional technology.

According to an aspect of the present invention, an image recognizing apparatus installed on a vehicle includes an image shooting unit installed on the vehicle and that shoots an image of an area around the vehicle at a set frame rate; a situation determining unit that determines a required response rate to detect a potential object of collision with the vehicle; a frame-rate controlling unit that controls the frame rate in the image shooting unit based on determined response rate; and a recognizing unit that recognizes whether there is an object in the image.

According to another aspect of the present invention, an image shooting apparatus installed on a vehicle includes an image shooting unit installed on the vehicle and that shoots an image of an area around the vehicle at a set frame rate; a situation determining unit that determines a required response rate to detect a potential object of collision with the vehicle; and a frame-rate controlling unit that controls the frame rate in the image shooting unit based on determined response rate.

According to still another aspect of the present invention, an image shooting control apparatus installed on a vehicle that controls an image shooting unit installed on a vehicle and that shoots an image of an area around the vehicle at a set frame rate includes a situation determining unit that determines a required response rate to detect a potential object of collision with the vehicle; and a frame-rate controlling unit that controls the frame rate in the image shooting unit based on determined response rate.

According to still another aspect of the present invention, a method of image recognition includes shooting an image of an area around the vehicle at a set frame rate with an image shooting unit installed on a vehicle; determining a required response rate to detect a potential object of collision with the vehicle; controlling the frame rate in the shooting based on determined response rate; and recognizing whether there is an object in the image.

According to still another aspect of the present invention, a method of shooting an image of an area around the vehicle includes shooting an image of an area around the vehicle at a set frame rate with an image shooting unit installed on a vehicle; determining a required response rate to detect a potential object of collision with the vehicle; and controlling the frame rate in the shooting based on determined response rate.

According to still another aspect of the present invention, a method of controlling an image shooting unit installed on a vehicle and that shoots an image of an area around the vehicle at a set frame rate includes determining a required response rate to detect a potential object of collision with the vehicle; and controlling the frame rate in the shooting based on determined response rate.

According to still another aspect of the present invention, a warning apparatus installed on a vehicle and operating with an image recognizing unit installed on the vehicle and that controls a frame rate in an image shooting unit based on a required response rate to detect a potential object of collision with the vehicle, the image shooting unit installed on the vehicle and shooting an image of an area around the vehicle at controlled frame rate, and the image recognizing unit recognizing whether there is an object in the image, includes a warning unit that provides a warning to at least one of a driver and passengers of the vehicle based on the recognition result obtained by the image recognizing unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a detailed functional block diagram of an image recognizing apparatus according to an embodiment of the present invention;

FIG. 2 is a table for explaining control of frame rate by the image recognizing apparatus shown in FIG. 1;

FIG. 3 is a schematic for explaining control of resolution by the image recognizing apparatus shown in FIG. 1;

FIG. 4 is a flowchart of processing performed by the image recognizing apparatus shown in FIG. 1;

FIG. 5 is a detailed functional block diagram of an image recognizing apparatus according to another embodiment of the present invention; and

FIG. 6 is a detailed functional block diagram of an image recognizing apparatus according to still another embodiment of the present invention.

### DETAILED DESCRIPTION OF THE PREFERRED EMBODIMENTS

Exemplary embodiments of the present invention will be explained below in detail with reference to accompanying drawings.

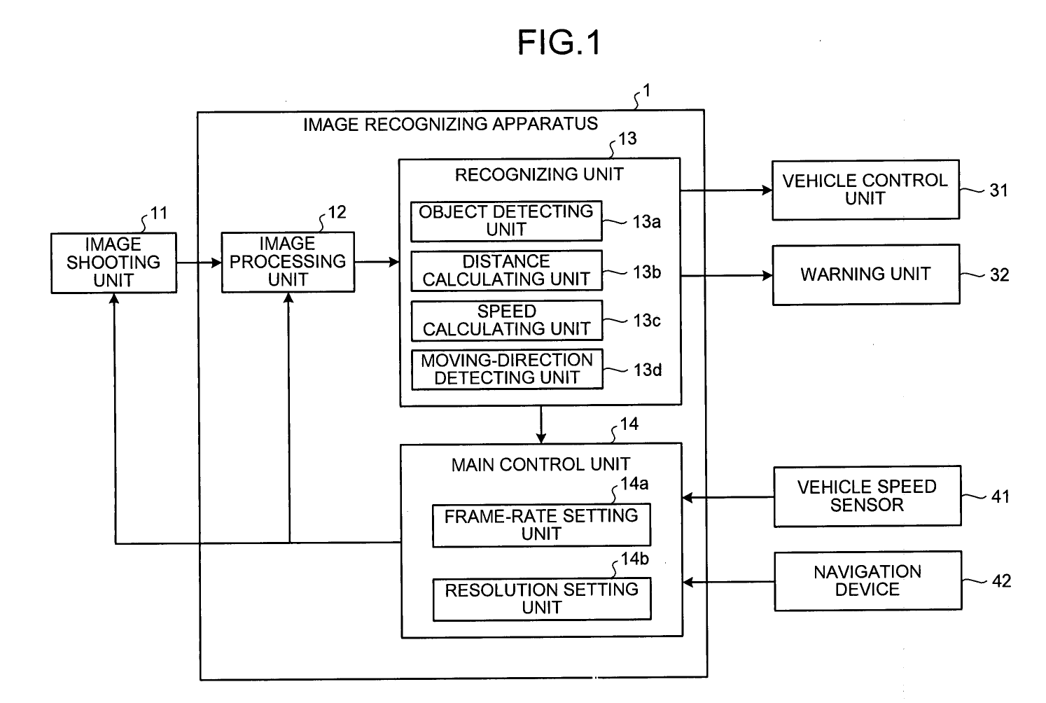

FIG. 1 is a detailed functional block diagram of an image recognizing apparatus 1 according to an embodiment of the present invention. The image recognizing apparatus 1 is installed on a vehicle. The image recognizing apparatus 1 performs image recognition on an image shot by an image shooting unit 11, which is installed on the vehicle, and performs a feedback control on the image shooting unit 11 so that the image shooting unit 11, shoots an image at a frame rate appropriate to a situation around the vehicle.

Specifically, the image recognizing apparatus 1 includes an image processing unit 12, a recognizing unit 13, and a main control unit 14. The image shooting unit 11 can be, for example, a charge coupled device (CCD) camera that can acquire frames of a moving picture at a certain frame rate. The frames are passed to the image processing unit 12 as image data. The image shooting unit 11 includes a means for capturing an image (not shown) at a set frame rate, and the frame rate is variable. The image processing unit 12 and the recognizing unit 13 process a frame based on the frame rate at which the frame was acquired.

The image processing unit 12 performs background change detection, i.e., separating an object such as a pedestrian from background, over a frame. The recognizing unit 13 performs pattern matching to a processing result (an image of a potential object as a pedestrian) obtained by the image processing unit 12.

The recognizing unit 13 includes an object detecting unit 13a, a distance calculating unit 13b, a speed calculating unit 13c, and a moving-direction detecting unit 13d. The object detecting unit 13a detects presence of an object by the pattern matching. Furthermore, the object detecting unit 13a detects a type of the object (such as a pedestrian).

When the object detecting unit 13a detects an object in a frame, the distance calculating unit 13b calculates a distance between the vehicle and the object based on a position and a size of the object in the frame. The speed calculating unit 13c calculates a moving speed of the object based on the distance between the vehicle and the object and an amount of movement of the object in the frame. The moving-direction detecting unit 13d detects a moving direction of the object based on change in the position and the size of the object in the frame.

The recognizing unit 13 outputs the result of the recognition (i.e., information, such as presence or absence, type, distance, moving speed, moving direction of the object) to a vehicle control unit 31, a warning unit 32, and the main control unit 14.

The vehicle control unit 31 performs operation control of the vehicle, such as engine control and braking control, and assists driving of the vehicle and performs risk avert control based on the recognition result. The warning unit 32 provides a warning to a driver or passengers of the vehicle based on the recognition result.

The main control unit 14 controls the image recognizing apparatus 1 and includes a frame-rate setting unit 14a and a resolution setting unit 14b. The frame-rate setting unit 14a sets a frame rate in the image shooting unit 11 based on a state of the vehicle and a situation around the vehicle, i.e. a driving situation of the vehicle.

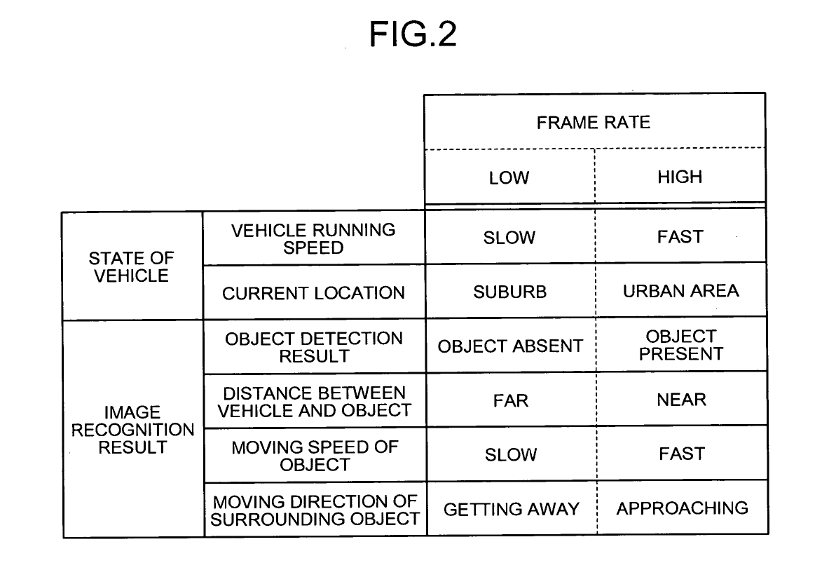

The frame-rate setting unit 14a sets the frame rate based on a table shown in FIG. 2. The frame-rate setting unit 14a acquires the speed of the vehicle from a vehicle speed sensor 41. When the speed is high, the frame-rate setting unit 14a sets a higher frame rate than when the speed is low. If the vehicle is moving fast, it approaches quickly toward the pedestrian, i.e., processes such as outputting the warning or controlling steering of the vehicle needs to be performed at earlier timing. By raising the frame rate in order to monitor the image with a higher pitch, a risk can be detected at earlier timing. In other words, the frame-rate setting unit 14a changes the frame rate in accordance with a driving situation of the vehicle in relation to timing for detecting a potential object of collision with the vehicle.

For example, suppose a pedestrian is present outside a road, and after a while the pedestrian enters into the road. (It is assumed that a warning is activated by none of pedestrians outside the road, but only a pedestrian who enters into the road.) In a conventional technology, suppose at a time T1, the pedestrian is present outside the road and detected, and then the pedestrian enters into the road and is detected at another time after the time T1 by ΔT regardless of a speed of the vehicle. A warning is activated at the time (T1+ΔT) at earliest. As a result, when an entrance of the pedestrian is noticed (i.e. the warning is activated), the higher speed results in the closer position of the pedestrian with respect to the vehicle.

By contrast, a case according to the embodiment is explained below. Likewise, suppose the pedestrian is present outside the road and detected at a time T1. When a speed of the vehicle is higher than a predetermined value at the moment, it is determined that the probability of a collision of the vehicle with the pedestrian is high and the vehicle is in a situation where the pedestrian should be detected as early as possible. The frame rate is then raised and time of processing of each frame is brought into earlier timing. As a result, a time period for detecting the entrance of the pedestrian into the road can be shorter than a conventional time period ΔT, thereby enabling earlier timing of a warning (a warning can be activated earlier).

Moreover, the frame-rate setting unit 14a acquires a location of the vehicle from a navigation device 42. If the vehicle is running through a crowded area or an area where special care needs to take in driving, such as an urban area, a school route, or an area where traffic accidents occur frequently, the frame-rate setting unit 14a sets a higher frame rate than when the vehicle is running through a relatively less crowded area.

Furthermore, the frame-rate setting unit 14a controls the frame rate by using the image recognition result obtained by the recognizing unit 13. Precisely, when the object detecting unit 13a detects an object in a frame, the frame-rate setting unit 14a raises the frame rate so that the subsequent frames are acquired at the higher frame rate. Moreover, if an object is detected in a frame, the distance calculated by the distance calculating unit 13b is shorter or the speed of the vehicle calculated by the speed calculating unit 13c is higher, the frame-rate setting unit 14a further raises the frame rate. If the moving direction of the object calculated by the moving-direction detecting unit 13d indicates that the object is approaching toward the vehicle, the frame-rate setting unit 14a raises the frame rate.

Thus, the frame rate is controlled based on a driving situation of the vehicle, so that a shooting appropriate to image recognition on the vehicle can be achieved.

Specifically, for example, suppose a frame rate can be set in a range between 1 and 10, and an initial rate is set at 5. When the vehicle is running fast, the frame rate is changed from 5 to 10. In addition, when a location of the vehicle is in countryside, the frame rate is decreased to 8. At this frame rate, an object is detected, and the object is then recognized. When the distance between the vehicle and the object is short, the current frame rate 8 is changed to 10. When a relative speed of approach of the object and the vehicle toward each other is low, the frame rate 10 is decreased to 8. When the object is moving away from the vehicle, the frame rate is further decreased to 6. Finally, the frame rate is determined to be 6. In other words, setting is changed at each step in order, and the frame-rate setting unit 14a informs the final frame rate to the image shooting unit 11.

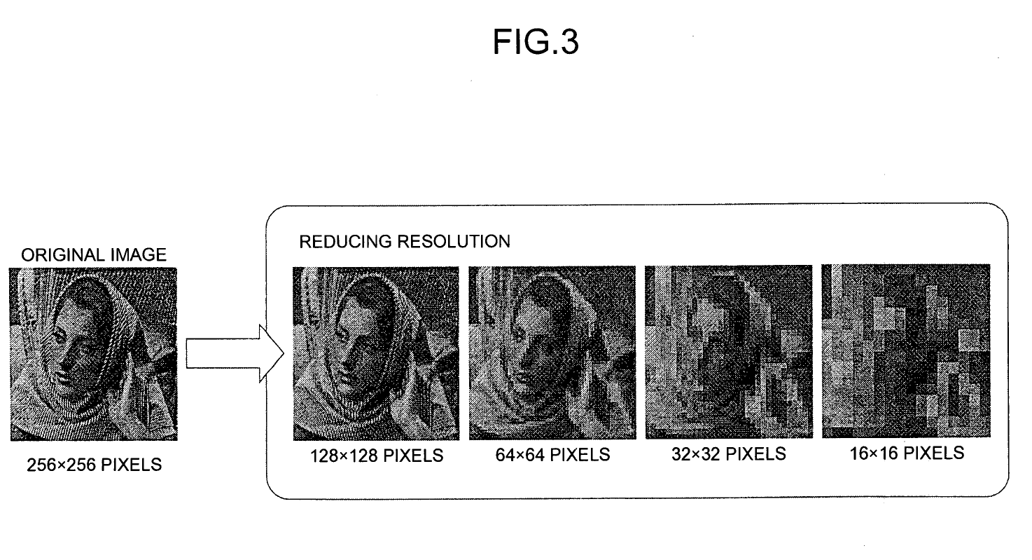

If the frame rate is raised, processing load increases; however, the resolution setting unit 14b reduces the resolution of an image as shown in FIG. 3 thereby decreasing the processing load.

It is desirable that the processing load is reduced so as to keep constant a throughput per unit time. However, reduction in resolution affects accuracy of image recognition, so that it is preferred that resolution is determined taking into account a frame rate, recognition accuracy, and a computing capacity of the image processing unit 12 and the recognizing unit 13.

Resolution can be controlled by directly controlling resolution for shooting with the image shooting unit 11, otherwise by controlling resolution for processing with the image processing unit 12.

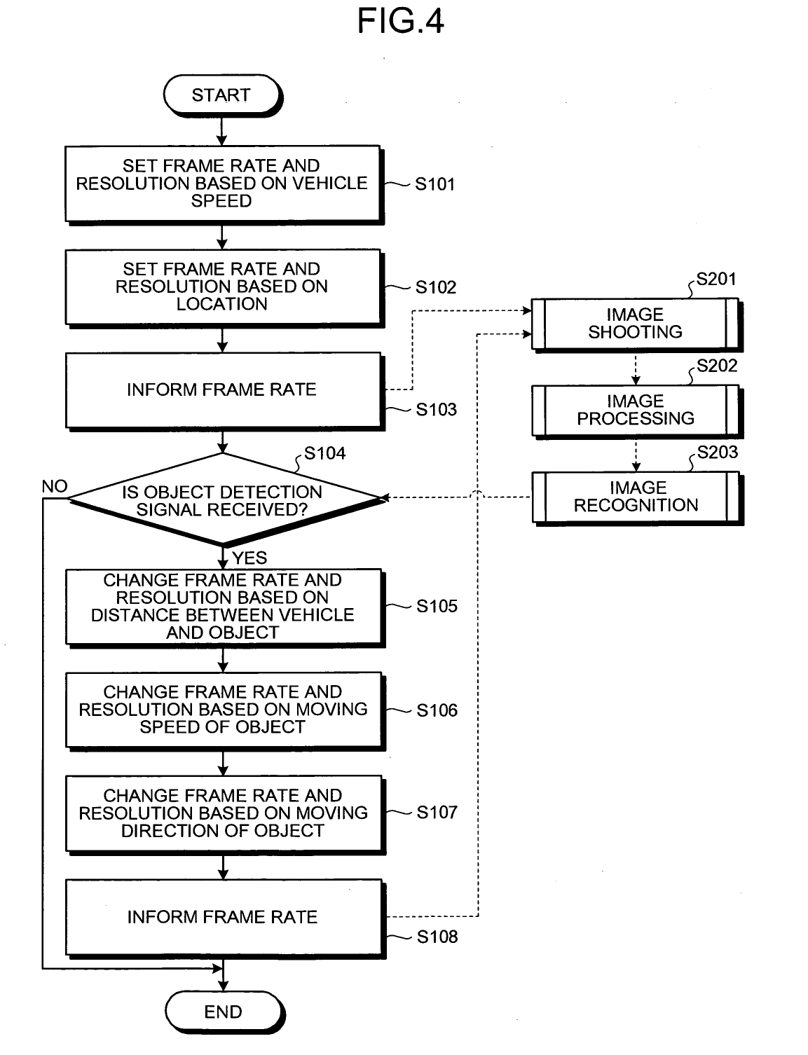

Next, processing operation performed by the image recognizing apparatus 1 is explained below with reference to a flowchart shown in FIG. 4. The processing shown in FIG. 4 is repeatedly executed when the image recognizing apparatus 1 shoots a moving picture.

To begin with, the main control unit 14 sets a frame rate and resolution in accordance with the speed of the vehicle measured by the vehicle speed sensor 41 (step S101), changes the frame rate and the resolution based on the location determined by the navigation device 42 (step S102), and informs the new frame rate to the image shooting unit 11 (step S103).

The image shooting unit 11 shoots frames at the new frame rate (step S201), and then the image processing unit 12 processes a frame (step S202), and the recognizing unit 13 performs image recognition on the frame (step S203). When an object is detected in the frame in the image recognition, the recognizing unit 13 transmits an object detection signal to the main control unit 14.

When the main control unit 14 does not receive an object detection signal from the recognizing unit 13 (step S104, No), the image recognizing apparatus 1 ends the processing (and then repeats the processing from step S101 again). On the contrary, when the main control unit 14 receives an object detection signal from the recognizing unit 13 (Yes at step S104), the main control unit 14 changes the frame rate and the resolution based on the distance between the vehicle and the object (step S105), further changes the frame rate and the resolution based on the moving speed of the object (step S106), and still further changes the frame rate and the resolution based on the moving direction of the object 13d (step S107). Finally, the main control unit 14 informs the new frame rate to the image shooting unit 11 (step S108), and ends the processing (afterwards, repeats the processing from step S101).

Thus, the image recognizing apparatus 1 according to the embodiment changes a frame rate and resolution based on a state of the vehicle, a situation around the vehicle, particularly a speed of a pedestrian, a distance between the vehicle and the pedestrian, and a moving direction of the pedestrian, thereby achieving a shooting of an image appropriate for detecting an object by image recognition along with achieving early detection of an object and reduction in throughput concurrently.

In the embodiment, the image recognizing apparatus 1, into which an image shooting unit, an image processing unit, and a recognizing unit are integrated, is explained as an example. However, the present invention is not limited to this, an image recognizing apparatus can have other configurations as desired.

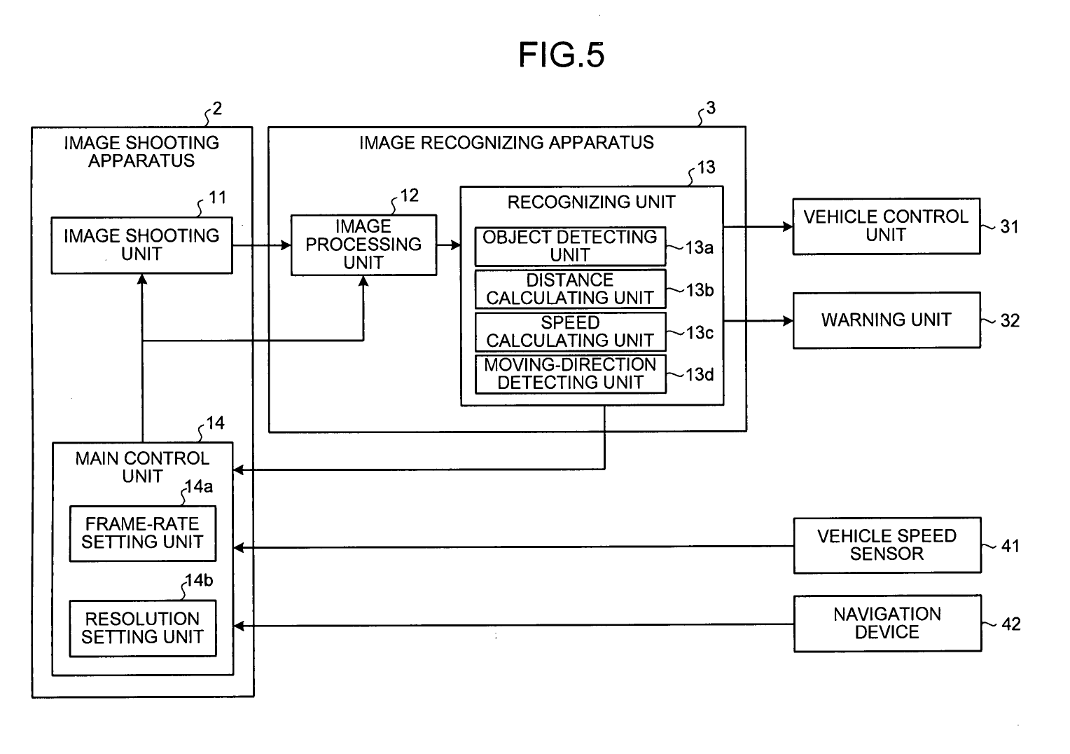

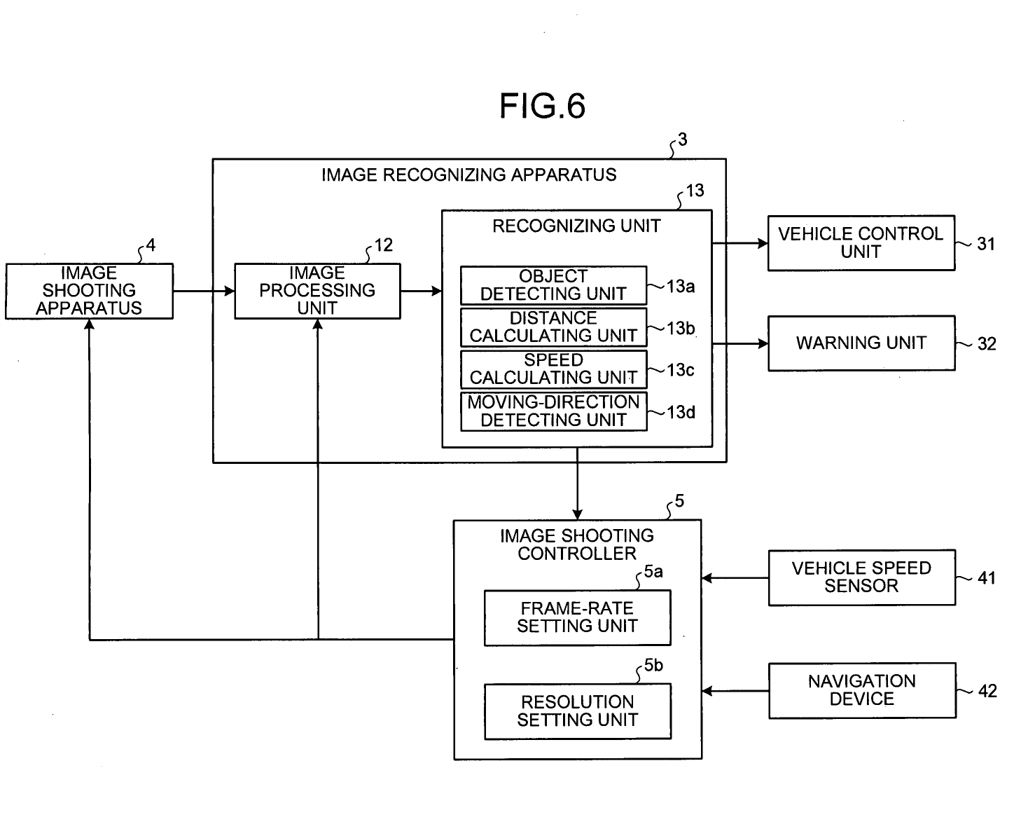

Image recognizing apparatuses according to other embodiments are shown in FIGS. 5 and 6. In FIG. 5, an image shooting apparatus 2 and an image recognizing apparatus 3 are designed as independent apparatuses. The main control unit 14 in the image shooting apparatus 2 receives information provided from the vehicle speed sensor 41, the navigation device 42, and the image recognizing apparatus 3 to set a frame rate and resolution.

In FIG. 6, the image recognizing apparatus 3, an image shooting apparatus 4, and an image shooting controller 5 are designed as independent apparatuses. The image shooting controller 5 receives information provided from the vehicle speed sensor 41, the navigation device 42, and the image recognizing apparatus 3, and externally controls a frame rate and resolution used in the image shooting apparatus 4.

Thus, similarly to the image recognizing apparatus shown in FIG. 1, another on-board imaging system having a different configuration can shoot an image appropriately for detecting an object by image recognition, within a scope of the present invention.

According to the embodiments of the present invention, early detection of an object and reduction in throughput can be achieved concurrently.

Furthermore, when an object is detected, a subsequent image can be shot at a higher frame rate.

Moreover, the subsequent image can be shot at a frame rate appropriate to a distance between a detected object and the vehicle.

Furthermore, the subsequent image can be shot at a frame rate appropriate to a speed of a relative approach between the detected object and the vehicle.

Moreover, the subsequent image can be shot at a frame rate appropriate to a direction of the detected object with respect to the vehicle.

Furthermore, an image can be shot at a frame rate and resolution appropriate for detecting an object by image recognition, along with achieving early detection of an object and reduction in throughput concurrently.

Moreover, a load of throughput can be kept at constant along with achieving early detection of an object.

Furthermore, the warning apparatus can provide a warning to a driver or passengers based on early detection of an object, while reducing throughput.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image recognizing apparatus installed on a vehicle, the image recognizing apparatus comprising:
an image shooting unit installed on the vehicle and that shoots an image of an area around the vehicle at a set frame rate;
a situation determining unit that determines a required response rate to detect a potential object of collision with the vehicle;
a frame-rate controlling unit that controls the frame rate in the image shooting unit based on determined response rate; and
a recognizing unit that recognizes whether there is an object in the image.

2. The image recognizing apparatus according to claim 1, wherein the frame-rate controlling unit increases current frame rate when the recognizing unit recognizes an object.

3. The image recognizing apparatus according to claim 2, further comprising a distance acquiring unit that acquires a distance between an object and the vehicle when the recognizing unit recognizes the object, wherein
the frame-rate controlling unit changes the frame rate based on the distance.

4. The image recognizing apparatus according to claim 2, further comprising a speed acquiring unit that acquires a speed of approach of an object and the vehicle toward each other when the recognizing unit recognizes the object, wherein
the frame-rate controlling unit changes the frame rate based on the speed of approach.

5. The image recognizing apparatus according to claim 2, further comprising a direction acquiring unit that acquires a direction of an object with respect to the vehicle when the recognizing unit recognizes the object, wherein
the frame-rate controlling unit changes the frame rate based on the direction.

6. The image recognizing apparatus according to claim 1, wherein the frame-rate controlling unit controls the frame rate in the image shooting unit based on a running speed of the vehicle.

7. The image recognizing apparatus according to claim 1, wherein the frame-rate controlling unit that controls the frame rate in the image shooting unit based on a current location of the vehicle.

8. The image recognizing apparatus according to claim 1, further comprising a resolution controlling unit that changes a resolution of an image based on the frame rate corresponding to the image.

9. The image recognizing apparatus according to claim 8, wherein the frame-rate controlling unit and the resolution controlling unit control the frame rate and the resolution such that a throughput per unit time is constant when recognizing the image.

10. An image shooting apparatus installed on a vehicle, the image shooting apparatus comprising:
an image shooting unit installed on the vehicle and that shoots an image of an area around the vehicle at a set frame rate;
a situation determining unit that determines a required response rate to detect a potential object of collision with the vehicle; and
a frame-rate controlling unit that controls the frame rate in the image shooting unit based on determined response rate.

11. An image shooting control apparatus installed on a vehicle that controls an image shooting unit installed on a vehicle and that shoots an image of an area around the vehicle at a set frame rate, the image shooting control apparatus comprising:
a situation determining unit that determines a required response rate to detect a potential object of collision with the vehicle; and
a frame-rate controlling unit that controls the frame rate in the image shooting unit based on determined response rate.

12. A method of image recognition comprising:
shooting an image of an area around the vehicle at a set frame rate with an image shooting unit installed on a vehicle;
determining a required response rate to detect a potential object of collision with the vehicle;
controlling the frame rate in the shooting based on determined response rate; and
recognizing whether there is an object in the image.

13. A method of shooting an image of an area around the vehicle, the method comprising:
shooting an image of an area around the vehicle at a set frame rate with an image shooting unit installed on a vehicle;
determining a required response rate to detect a potential object of collision with the vehicle; and
controlling the frame rate in the shooting based on determined response rate.

14. A method of controlling an image shooting unit installed on a vehicle and that shoots an image of an area around the vehicle at a set frame rate, the method comprising:
determining a required response rate to detect a potential object of collision with the vehicle; and
controlling the frame rate in the shooting based on determined response rate.

15. A warning apparatus installed on a vehicle and operating with an image recognizing unit that is installed on the vehicle and controls a frame rate in an image shooting unit based on a required response rate to detect a potential object of collision with the vehicle, the image shooting unit installed on the vehicle and shooting an image of an area around the vehicle at controlled frame rate, and the image recognizing unit recognizing whether there is an object in the image, the warning apparatus comprising:
a warning unit that provides a warning to at least one of a driver and passengers of the vehicle based on the recognition result obtained by the image recognizing unit.
